(19) United States
(12) Patent Application Publication
(10) Pub. No.: US 2023/0177508 A1
(43) Pub. Date: Jun. 8, 2023

(54) Contactless Biometric Authentication Systems and Methods Thereof

(71) Applicant: RI Pty Ltd., Red Hill (AU)

(72) Inventor: Rikesh Ram, Springfield Lakes (AU)

(21) Appl. No.: 17/924,380

(22) PCT Filed: May 12, 2021
(86) PCT No.: PCT/AU2021/050447

§ 371 Date: Nov. 10, 2022

(30) Foreign Application Priority Data
May 18, 2020 (AU) 2020901588
Aug. 10, 2020 (AU) 2020101743

(51) Int. Cl. G06Q 20/40; H04L 9/40

(52) U.S. Cl. CPC G06Q 20/40145; H04L 63/0861

(57) ABSTRACT

A biometric authentication system for authenticating user(s) without requesting any personal information or device from the user(s) is disclosed. The system includes an onboarding module to enable the user(s) to register with the system. An input module receives the registration information from the user(s) and a machine learning module detects blur and bad image in the registration information. A verification module registers the user and creates a record by verifying the registration information with an issuing authority. A 3D liveliness detection module scans a face of the user, and creates a 3D face map of the user in real-time. An authentication module authenticates an identity of the user by searching for a matching record based on the face scan from pre-stored records and when a matching record is found. The user is authenticated without requesting any personal information and also 3D face map is deleted after authentication.

### CROSS-REFERENCE TO RELATED APPLICATIONS

This application is the national stage application of International Application No. PCT/AU2021/050447 filed May 12, 2021 which designates the United States of America. This application also claims priority, under 35 U.S.C. § 119, to Australian Patent Application No. 2020901588 filed May 18, 2020 and Australian Patent Application No. 2020101743 filed Aug. 10, 2020. The prior applications are herein incorporated by reference in their entirety.

### TECHNICAL FIELD

The presently disclosed subject matter generally relates to the field of contactless authentication and payment. Particularly, the present subject matter relates to a biometric authentication system and method for authenticating a user based on 3D scanning of at least one body part of the user and/or authorising a payment based on the authentication. The user may not require to present any device or a physical or virtual payment information for authentication and/or payment.

### BACKGROUND

It would be attractive, practically and commercially, to provide a contactless authentication and/or payment system that may enable a user to authenticate their identity without actually showing a physical ID or device or entering personal information. This may prevent a user from frauds that may happen in case user loses the physical ID or the device.

There exist many contactless payment systems that utilize near field communication (NFC) technologies. Users love the convenience and speed of paying with a contactless card or other contactless device with no more fumbling for cash, counting change, or worrying about whether they have enough cash for a purchase or not. In many cases, users don't even need to sign a payment card receipt or enter a personal identification number (PIN). Contactless payment is also attractive for merchants where speed and convenience of payment are essential, for example, gas stations, entertainment venues, quick service restaurants, convenience stores, parking facilities, unstaffed vending locations, and transit service.

Contactless payment can include paying via account, card-based payment, and stored credit or gift card-based payment. Many transaction processors (or card operators) such as American Express, JCB, MasterCard, and Visa have all established contactless payment systems that are being used in major cities around the world. Usually, contactless payment requires a wireless information exchange between a user's payment token and a payment terminal or infrastructure device or a merchant. Contactless payment can be enabled using a variety of technologies such as, but not limited to, Radio frequency (RFID) technology. These systems use high-frequency solutions, low-frequency proprietary RF solutions, and ultra-high-frequency RF solutions.

Further, many places like service centers, entertainment venues, hospitals, clinics, clubs etc. may ask for an identity proof from users/consumers to authenticate their identity prior to entry or providing access to the places to the user. Currently, the authentication happens based on physical identity cards etc. like government issued identity cards/documents. Therefore, the user may need to carry the identity cards everywhere, which if lost can create a lot of inconvenience for the user.

Further, many financial institutions like banks issues their customers (i.e., the user) a chip-based debit or credit card. The user may make a payment by scanning the chip-based debit or credit card on a payment machine of a merchant. The user needs to carry the physical cards everywhere for payment. If the cards are lost the user may not be able to make the payment and if some other person finds the card, then the cards may be misused by some other person. The cards are commonly used for money transactions instead of carrying cash. At the same time, the unauthorised transaction has become a serious problem, costing the consumers millions of dollars annually. Therefore, other methods of transaction to minimize unauthorised transactions are becoming more desirable.

Some merchants use biometric systems or instruments based on fingerprint for safeguarding against unauthorised users. A fingerprint based biometric transaction system uses finger scanning to identify a user. In this method, a consumer scans his/her index finger using a point of sale (POS) finger scan reader. The finger scan reader encrypts multiple point-to-point measurements of the fingerprint and stores the customer's biometric data and banking information in a centralized database. Fingerprints are unique to each user, and their use eliminates remembering any password. The currently used fingerprint systems connect user's pre-collected and saved fingerprint to a particular account for payment. During a transaction, the user simply puts his/her finger on the payment terminal scanner so that his/her fingerprint can be scanned. The information is then sent to a payment server. The server verifies the fingerprint against a pre-collected fingerprint, and completes the payment once it authenticates the newly scanned fingerprint. Although the technologies for fingerprint collection and recognition are quite mature, a simple method of using fingerprint for payment is still potentially unsafe. Such devices can suffer from interference from latent fingerprints left on the scanner platen, high failure to acquire rates due to variations in skin condition (dry, moist, oily, or worn), and variation in prints due to varying amounts of pressure during the scan. Further, in some conventional systems for acquiring fingerprint images movement of the finger may cause distortion of the examined finger while capturing the fingerprint image. Additionally, such systems are not contactless.

Further, there exist systems that enable consumers to make payment by smiling and entering some personal information such as phone number, date of birth etc. These systems also suffer from limitations as the consumer have to enter a PIN or their personal information that may be misused and also these systems are not completely contactless.

Presently, some financial institutions also allow the user to set up a virtual payment means on their associated smart phone, watch etc. For example, while making a payment the user can simply open the virtual payment means on their smart phone or watch and the merchant's payment machine may scan the device from a distance. This is convenient for users as user don't have to carry their credit or debit cards everywhere, they can simply pay for the services via their devices. But the user requires the device at the time of the payment. Additionally, as the scanning from a distance is possible, therefore there are chances of the card details getting scanned by other devices/machines in vicinity. This may be dangerous for user's finances. Further, if the device is misplaced, then all financial details of the user may get compromised.

A method for generating a digital ID based on user's face images, the images can be still or video is disclosed in US 2020/0042685 A1 (FACETEE, INC.). The user images or data derived therefrom is transmitted to a verification server to determine if the images represent a live person. An image of ID of a photo identification such as a driver's license of the user is captured and transmitted to the verification server. The user images or data derived therefrom is compared to the image of the user on the photo identification to determine if user in the user images is the same person as the image on the photo identification. Responsive to a match from the comparison and a determination that a live person was captured in the user images, a digital ID is generated for the user and the digital ID is transmitted to the user. The US 2020/0042685 A1 (FACETEE, INC.) also disclosed payment to the merchant using a unique identifying transaction number (such as a PIN) that is generated during the time of the transaction and the user may need to tell this number to the merchant or seller. Therefore, in this the user still needs to tell a pin or some information for completing the payment.

Another patent application US20200036528A1 (ROYAL BANK OF CANADA) discloses systems and methods for authentication using secure tokens. An individual's personal information is encapsulated into transformed digitally signed tokens, which can then be stored in a secure data storage (e.g., a “personal information bank”) and/or on the mobile device of the user. The digitally signed tokens can include blended characteristics of the individual such as 2D/3D facial representation, speech patterns) that are combined with digital signatures obtained from cryptographic keys (e.g., private keys) associated with corroborating trusted entities such as, a government, a bank or organizations of which the individual purports to be a member e.g., a club. It also discloses using a PIN as a second-factor authentication while making a transaction. Further, In Enhanced Enrolment, the user needs to take and present physical ID to an enrolment location such as bank branch. Therefore, in this method also the user needs to provide a PIN (for example via speaking or lip reading) for authenticating a transaction.

Further, the existing system or methods do not verify the individual Identity as the user does not scan any Identity documents and this again is not verified by any cross reference with the issuing authority data base.

In light of above, there is a need for contactless systems that can authenticate a user for making one or transactions like payment, document retrieval etc.

It is an object of the present invention to overcome or ameliorate the above discussed disadvantages of the prior art, or at least offer a useful alternative.

### SUMMARY

To overcome the above-mentioned limitations and problems, the present disclosure provides a biometric authentication system that may be a contactless system and doesn't require any information from the user for authenticating a transaction. The transaction may be a payment transaction. In some embodiments, the transaction may be a report or document fetching request or transaction. The system is configured to authenticate the user by scanning a face or a body part of the user and hence the user may not need to provide any personal information or document for authentication. An embodiment of the present disclosure also provides a biometric authentication and payment system that authenticates the user and process a payment for a transaction of a user without requiring the user to present any payment card or information to a merchant. In some embodiments, the biometric authentication and payment system also allows an entity authenticated by the user to retrieve or fetch report or document(s) of the user post authentication of the user. The non-limiting examples of the report or documents may include a medical test report, visa document, a driving license, a passport, a medical card, financial documents, a blood test report, medical history, and policy compliance document.

The present disclosure provides a contactless biometric authentication system and method for authenticating an identity of a user based on 3D scanning of at least one body part such as, but not limited to, a face of the user and/or authorising a payment accordingly without requiring the user to present a physical or virtual payment means.

The present disclosure provides a contactless biometric authentication system configured to allow one or more businesses to establish genuine identity (ID) of their users by verifying government issued IDs in real time. The system is configured to enable a user to link a payment solution such as, but not limited to, a debit card, a PayPal account, a credit cards, bank account with the system to process payments once user's ID has been verified. The system may also be configured to instantly issue other payment methods such as virtual payments cards based on the verification of the user's identity. Further, the system may allow the user to use cryptocurrency to make payments to merchants or the businesses accepting cryptocurrency.

An embodiment of the present disclosure provides a biometric authentication system for authenticating a plurality of users without requesting any personal information or device from the plurality of users. The system includes an onboarding module configured to enable the plurality of users to register with the biometric authentication system. The onboarding module includes an input module configured to receive registration information from a user of the plurality of users, wherein the registration information comprises at least one of image, a video, one or more reports, and one or more identity document of the user. The onboarding module also includes a machine learning module configured to detect blur and bad image. The onboarding module further includes a verification module configured to verify the registration information with one or more issuing authority to determine whether they are authentic and are associated with the user; and register the user based on the verification, wherein a record is created for the user on successful verification and registration. The system also includes a three-dimensional (3D) liveliness detection module configured to: scan a face of the user; and create a 3D face map of the user in real-time based on the scanning. The system also includes an authentication module configured to authenticate an identity of the user by searching for a matching record based on the scanning of the face from a plurality of pre-stored records of the plurality of users. The user is authenticated when the matching record is found. Otherwise, the authentication module prompts the user to register when the matching record is not found, wherein no personal information is requested from the user for authentication. Further, the 3D liveliness detection module deletes the face map of the user after completion of the searching of the matching record.

According to an aspect of the present disclosure, the authentication module may be configured to determine if the user is who they claim to be by leveraging the one or more identity document and at least one of the image and video (or audio) of the user.

According to another aspect of the present disclosure, the 3D liveliness detection module is a contactless module and is further configured to: perform an instant liveliness test from at least one of the video, image and the scanning of the face of the user; and measure one or more properties from the created 3D map of the user, wherein the one or more properties comprises a 3D depth, skin texture, and eye reflections of the user.

According to another aspect of the present disclosure, the machine learning module is configured to: continuously update onboarded users' personal data and facial features in their respective records; and perform data tagging to identify at least one of if the image was scuffed, if the identity document had a hole punched, which country was the identity document from, if there is a glare in the video or image, and if part of the video or image is obscured by a thumb.

According to another aspect of the present disclosure, the input module is further configured to receive payment information from the user at the time of registration.

According to another aspect of the present disclosure, the verification module may verify the payment information and associate the payment information with the record of the user, wherein the verification module verifies the payment information by coordinating with respective issuing authority of the one or more issuing authority. The respective issuing authority may be an authority or third party that issued the payment information to the user.

According to another aspect of the present disclosure, the biometric authentication system also includes a payment module configured to process a payment for a transaction of the user based on the authentication of the user without requesting any personal information from the user.

According to another aspect of the present disclosure, the authentication module may authenticate the user based on at least one of an image, a video of the user, and an identifier provided by the user.

According to another aspect of the present disclosure, the biometric authentication system also includes an automatic report fetching module configured to enable an entity authorised by the user to access at least one report of the one or more reports of the user after authentication of the user.

The entity may a person, any other user, or a company authorised by the user to access the reports or documents of the user. The non-limiting examples of the entity may include a medical practitioner, a doctor, and so forth. In some embodiments, the entity may be a website, or a mobile application that the user authorised to access his/her reports or documents. The entity may access the biometric authentication system on a computing device such as, but not limited to, a mobile phone, a computer, a laptop, a scanning device, and so forth.

Further, the automatic report fetching module may enable the user to upload the one or more reports. The user may upload the document or report by one or more means such as, but not limited to, clicking picture of the report/document, scanning the report/document, or by inputting data into the system. In some embodiments, the automatic report fetching module may enable the user to restrict access of some of the one or more reports/documents for the entity. The automatic report fetching module may also enable the user to authorise the entity prior to allowing them to access user's reports/documents.

Another embodiment of the present disclosure provides a method for authenticating a plurality of users without requiring the plurality of users to present any device or personal information, comprising enabling, by an onboarding module, the plurality of users to register with a biometric authentication system by: receiving, by an input module, registration information from a user of the plurality of users, wherein the registration information comprises at least one of image and a video and one or more identity document of the user; detecting, by a machine learning module, blur and bad image in the registration information; and verifying, by a verification module, the registration information with one or more issuing authority to determine whether they are authentic and are associated with the user; and registering, by the verification module, the user based on the verification, wherein a record is created for the user on successful verification and registration. The method also includes scanning, by a three-dimensional (3D) liveliness detection module, a face of the user; and creating, by the 3D liveliness detection module, a 3D face map of the user in real-time based on the scanning of the face. The method further includes authenticating, by an authentication module, an identity of the user by searching for a matching record based on the scanning of the face from a plurality of pre-stored records of the plurality of users, wherein the user is authenticated when the matching record is found, further wherein the authentication module prompts the user to register when the matching record is not found, wherein no personal information is requested from the user for authentication. In some embodiments, the 3D liveliness detection module deletes the face map of the user after completion of the searching of the matching record.

According to an aspect of the present disclosure, the method further comprising, determining, by the authentication module, if the user is who they claim to be by leveraging the one or more identity document and at least one of the image and video of the user.

According to another aspect of the present disclosure, the method further includes performing, by the 3D liveliness detection module, an instant liveliness test from at least one of the video, image, and the face scan of the user. The 3D liveliness detection module is a contactless module. The at least one of the video, the image, and the face scan is captured by a computing device for example by a smart phone of the user.

According to another aspect of the present disclosure, the method further includes measuring, by the 3D liveliness detection module, one or more properties from the created 3D map of the user, wherein the one or more properties comprises a 3D depth, skin texture, and eye reflections of the user.

According to another aspect of the present disclosure, the method also includes deleting, by the 3D liveliness detection module, the face map of the user after completion of the searching of the matching record.

According to another aspect of the present disclosure, the method also includes: continuously updating, by the machine learning module, onboarded users' personal data and facial features in their respective records; and performing data tagging, by the machine learning module, to identify at least one of if the image was scuffed, if the identity document had a hole punched, which country was the identity document from, if there is a glare in the video or image, and if part of the video or image is obscured by a thumb.

According to another aspect of the present disclosure, the method also includes receiving, by the input module, payment information from the user at the time of registration; and verifying, by the verification module, the payment information and associating the payment information with the record of the user by coordinating with respective issuing authority of the one or more issuing authority.

According to another aspect of the present disclosure, the method also includes processing, by a payment module, a payment for a transaction of the user based on the authentication of the user without requesting any personal information from the user.

According to another aspect of the present disclosure, the method further includes authenticating, by the authentication module, the user based on at least one of an image, a video of the user, and an identifier provided by the user. The identifier may be a unique code or pin set by the user during the registration with the system.

In some embodiments, the method also includes enabling, by the authentication module, the user to authorise an entity. Further, the method includes enabling, by an automatic report fetching module, the authorised entity by the user to access at least one report of the one or more reports of the user after authentication of the user.

A yet another embodiment of the present disclosure provides a contactless biometric authentication system for authenticating a plurality of users without requiring the plurality of users to present any device or personal information. The system includes an onboarding module configured to enable the plurality of users to register with the contactless biometric authentication system. The onboarding module includes an input module configured to receive registration information from a user of the plurality of users. The registration information may include at least one of image and a video, a gesture, one or more identity document, confidential information, and payment information of the user. The onboarding module also includes a verification module configured to: verify the registration information with one or more issuing authority to determine whether they are authentic and are associated with the user; verify the payment information and associates the payment information with the record of the user; and register the user based on the verification, wherein a record is created for the user on successful verification and registration. The system also includes a three-dimensional (3D) liveliness detection module configured to: scan at least one of a body part, a facial expression, and a gesture of the user; and create a 3D map of the user in real-time based on the scanning. Further, the system also includes an authentication module configured to authenticate an identity of the user by searching for a matching record based on the scanning from a plurality of pre-stored records of the plurality of users, wherein the user is authenticated when the matching record is found. The authentication module may prompt the user to register with the system when the matching record is not found, wherein no personal information is requested from the user for authentication. The 3D liveliness detection module deletes the 3D map of the user after completion of the searching of the matching record. The system also includes a payment module configured to process a payment for a transaction of the user based on the authentication of the user.

According to an aspect of the present disclosure, the at least one body part comprises at least one of a face, a palm, a thumb, at least one finger, hand, and at least one eye of the user.

In some embodiments, the contactless biometric authentication system also includes an automatic report fetching module configured to enable an entity authorised by the user to access at least one report of the one or more reports of the user after authentication of the user.

Another embodiment of the present disclosure provides a biometric authentication system for authenticating a plurality of users without requesting any personal information or device from the plurality of users. The system includes an onboarding module configured to enable the plurality of users to register with the biometric authentication system. The onboarding module includes an input module configured to receive registration information from a user of the plurality of users. The non-limiting examples of the registration information includes an image, a video and one or more identity document of the user. The onboarding module also includes a machine learning module configured to detect blur and bad image; and perform data tagging to identify at least one of if the image was scuffed, if the identity document had a hole punched, which country was the identity document from, if there is a glare in the video or image, and if part of the video or image is obscured by a thumb. The onboarding module also includes a verification module configured to: verify the registration information with one or more issuing authority to determine whether they are authentic and are associated with the user; and register the user based on the verification, wherein a record is created for the user on successful verification and registration. The system also includes a three-dimensional (3D) liveliness detection module configured to: scan a face of the user; and create a 3D face map of the user in real-time based on the scanning. The system also includes an authentication module configured to authenticate an identity of the user by searching for a matching record based on the scanning of the face from a plurality of pre-stored records of the plurality of users. The user is authenticated when the matching record is found, further wherein the authentication module prompts the user to register when the matching record is not found, wherein no personal information is requested from the user for authentication. In some embodiments, the 3D liveliness detection module deletes the face map of the user after completion of the searching of the matching record. The system also includes an automatic report fetching module configured to enable an entity authorised by the user to access at least one report of the one or more reports of the user after authentication of the user.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1A is a schematic diagram illustrating an exemplary environment, where various embodiments of the present disclosure may function;

FIG. 1B is a schematic diagram illustrating another exemplary environment, where various embodiments of the present disclosure may function

FIG. 2A is a block diagram illustrating various system elements of an exemplary biometric authentication system, in accordance with an embodiment of the present disclosure;

FIG. 2B is a block diagram illustrating various system elements of another exemplary biometric authentication system, in accordance with an embodiment of the present disclosure;

FIG. 2C is a block diagram illustrating various system elements of another exemplary biometric authentication system, in accordance with an embodiment of the present disclosure;

FIG. 2D is a block diagram illustrating various system elements of another exemplary biometric authentication system, in accordance with an embodiment of the present disclosure;

FIGS. 3A-3B is a flowchart diagram illustrating a method for authenticating a user by using the exemplary contactless biometric authentication system of FIG. 2A, in accordance with an embodiment of the present disclosure;

FIG. 4 is a flowchart diagram illustrating a method for authenticating a user by using the exemplary contactless biometric authentication system of FIG. 2B, in accordance with an embodiment of the present disclosure; and

FIGS. 5A-5C is a flowchart diagram illustrating a method for automatically fetching one or more report(s) of a user after authenticating the user by using the exemplary contactless biometric authentication system of FIG. 2C, in accordance with an embodiment of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

The functional units described in this specification have been labeled as devices or modules. A device or module may be implemented in programmable hardware devices such as processors, digital signal processors, central processing units, field programmable gate arrays, programmable array logic, programmable logic devices, cloud processing systems, or the like. The devices/modules may also be implemented in software for execution by various types of processors. An identified device/module may include executable code and may, for instance, comprise one or more physical or logical blocks of computer instructions, which may, for instance, be organized as an object, procedure, function, or other construct. Nevertheless, the executable of an identified device/module need not be physically located together, but may comprise disparate instructions stored in different locations which, when joined logically together, comprise the device/module and achieve the stated purpose of the device/module.

Indeed, an executable code of a device or module could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as, but not limited to, TCP/IP, HTTP, XML, SOAP, REST, JSON and other sufficient protocols. The disclosed computer programs can be written in any existing or future developed programming languages that execute from memory on the device or from a hosted server, such as, but not limited to, BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

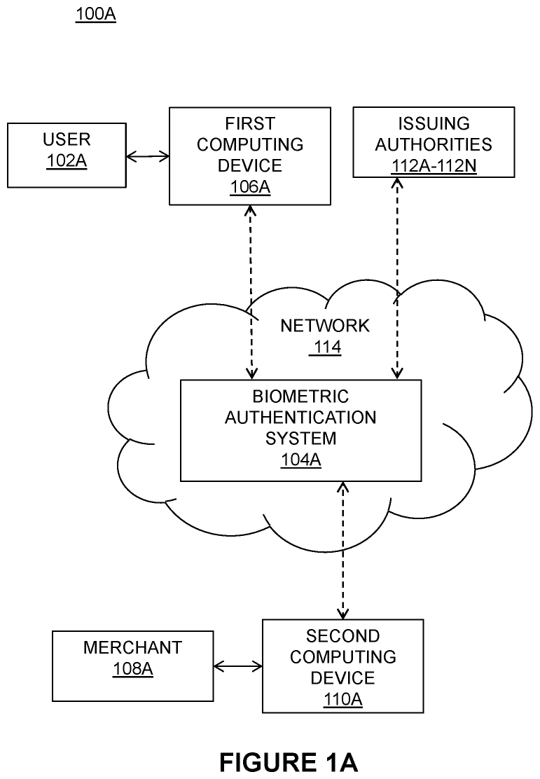

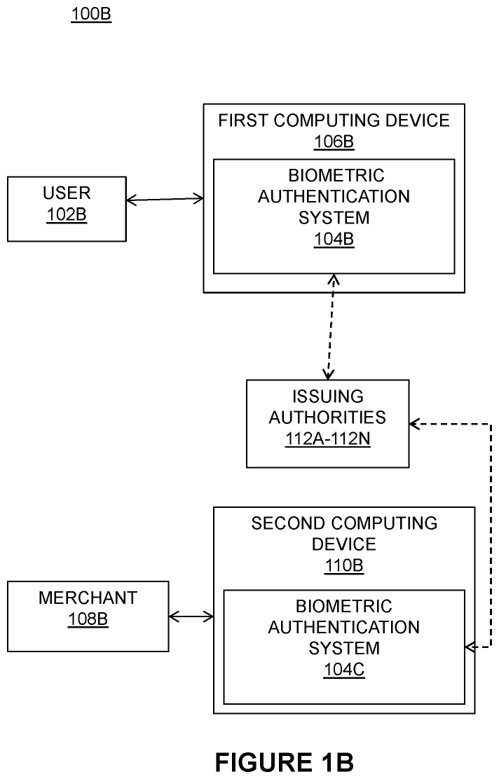

FIG. 1A is a schematic diagram illustrating an exemplary environment 100A, where various embodiments of the present disclosure may function. As shown, the environment 100A includes a user 102A, a first computing device 106A associated with the user 102A, a biometric authentication system 104A that may be present in a network 114, a merchant 108A, a second computing device 110A, and a number of issuing authorities 112A-112B. A person ordinarily skilled in the art will understand that the environment 100A may include more than one user 102A and the merchant 108A. In some embodiments, the merchant 108A may be an entity i.e., a person, a company, a mobile application, or a website that may access the system 104A for viewing one or more reports (e.g., medical reports, visa documents, financial reports, ID documents etc.) of the user 102A. The entity may be a pre-authorised by the user 102A. In some embodiments, the user 102A may authorise the entity at the time the entity request access to the reports of the user 102A.

The user 102A may be a consumer, a client or any person who need to interact with the merchant 108A for one or more service or products. The user 102A may access the biometric authentication system 104A for registration via the first computing device 106A. Hereinafter, the biometric authentication system 104A may also be referred as a system 104A without change in its meaning or functionality. The non-limiting examples of the first computing device 106A may include a smart phone, a computer, a web camera, a laptop computer, a tablet computer, a smart television, a smart watch, a smart camera, and so forth. In some embodiments, the user 102A may download and install the system 104A from the network 114 on the first computing device 106A. For example, the user 102A may download the system 104A as a mobile application from Google play store on an android operating system-based phone. In alternative embodiments, the user 102A may access the system 104A by entering a network link or uniform resource locator (URL) in a browser on the first computing device 106A. The user 102A may require to register with the system 104A for accessing one or more functionality of the system 104A. The system 104A may be present in a network device like a server located in the network 114. In other embodiments, the system 104A may be located in a cloud network.

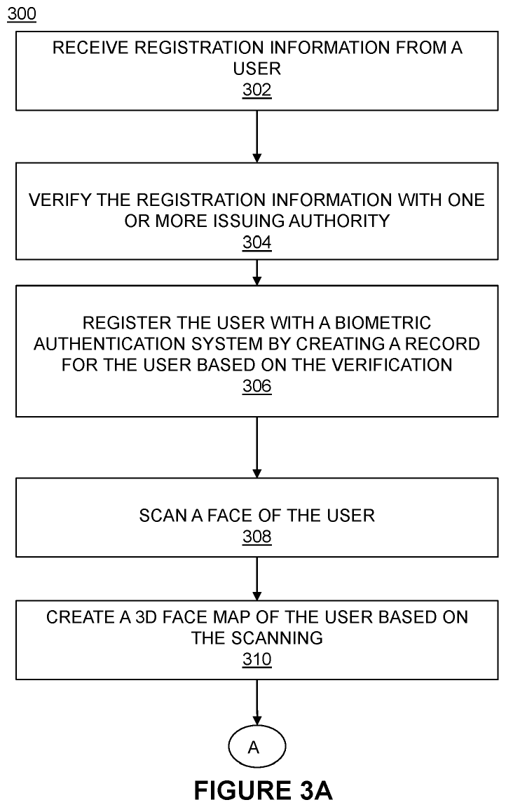

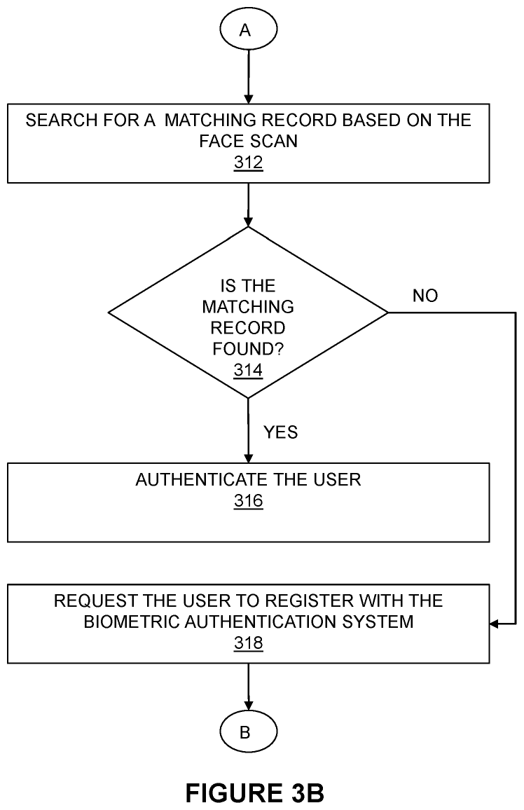

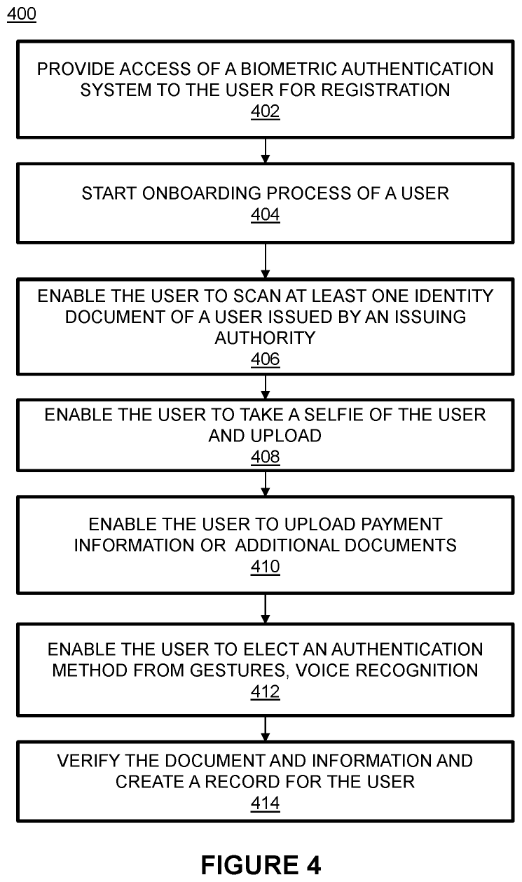

The merchant 108A may be any organisation, business, or person providing one or more product or service to the user 102A. Examples of the merchant 108A may include, but are not limited to, a shopkeeper, a super market, a shop, a restaurant, a club, a hospital, a clinic, a financial institution, and so forth. The merchant 108A may access the system 104A via the second computing device 110A. The non-limiting examples of the second computing device 110A may include a 3D scanner, a camera, a computer, a laptop computer, a tablet computer, a web camera, a biometric scanner, a smart watch, a smart TV, and so forth. In some embodiments, the merchant 108A may download and install the system 104A from the network 114 on the second computing device 110A. For example, the merchant 108A like a supermarket owner may download the system 104A as a mobile application from Google play store on an android operating system-based phone. In alternative embodiments, the merchant 108A may access the system 104A by entering a network link or uniform resource locator (URL) in a browser on the second computing device 110A. The merchant 108A may need to register with the system 104A for accessing one or more functionality of the system 104A. The onboarding or registration process of the user 102A or the merchant 108A is discussed in more detail in FIGS. 3A-3B and FIG. 4.

Turning now to FIG. 1B, where another exemplary environment 100B is illustrated. As shown, the environment 100B includes a user 102B having an associated first computing device 106B including a biometric authentication system 104B. The environment 100B also includes a merchant 108B having an associated second computing device 110B including a biometric authentication system 104C. The user 102B may be similar to the user 102A and the merchant 108B may be similar to the merchant 108A.

In some embodiments, the biometric authentication system 104B may be designed specifically for the user 102B and may include modules or devices for enabling the user 102B to register with the biometric authentication system 104B. Similarly, the biometric authentication system 104B may be designed specifically for the merchant 108B and may include modules or devices for enabling the merchant 108B to register with the biometric authentication system 104B and authenticate a plurality of users interacting with the merchant 108B. In some embodiments, the biometric authentication system 104B may also include device or modules for processing a payment for a transaction of a plurality of users.

Hereinafter, the biometric authentication system 104B may also be referred as the system 104B and the biometric authentication system 104C may also be referred as the system 104C without change in its meaning.

As shown, the user 102B may initiate an onboarding process with the system 104B. For example, the user 102B may capture a selfie image or a video of the self and upload on the system 104B. The user may also upload an identity document such as a driver's license. In some embodiments, the identity document may be a government issued identity document. The system 104B may then verify the driver's license with at least one issuing authority (like a driver's license issuing authority) of the issuing authorities 112A-112N. Upon verification, the system 104B may create a record corresponding to the user 102B and store. In some embodiments, the system 104B may store the record of the user 102B in a central storage device or database on a server that may be accessible by the system 104C of the merchant 108B. When the user 102B makes a transaction with the merchant 108B, the second computing device 110B i.e., a 3D scanner may scan a face of the user 102B and the system 104C may find a matching record corresponding to the face scan of the user 102B. The system 104C may authenticate the user 102B if a matching record is found and the face map is deleted or never stored on the system 104C. Else the system 104C may request the user 102B to register with the system 104C. The user 102B may register with any of the system 104B, or 104C, upon successful registration, the information of the user 102B i.e., the consumer gets stored in the central storage device accessible by the systems 104B and 104C. In some embodiments, the user records may also be saved locally on the systems 104B and 104C. Additionally, the second computing device 110B (or 110A) is a contactless device and may capture image or video of the user 102B (or 102A) without requiring any contact with the user 102B (or 102A). In some embodiments, the user 102B may provide payment information for example, the credit or debit card details while registration. In this case, the system 104B (or 104C) may also verify the payment information with respective issuing authority and may store in the record of the user 102B on successful verification. In such scenario, the system 104C may enable the user 102B to pay for the transaction to the merchant 108B. Therefore, the system 104C may enable the user 102B to authenticate their identity to the merchant 108B without providing any personal information like mobile number, date of birth, an address, etc. Further, in some embodiments, the system 104C may enable the user 102B to make a contactless payment for a transaction with the merchant 108A without disclosing any of their personal information like mobile number, date of birth, an address, etc. To the merchant 108B. The biometric authentication system 104A and 104B may allow the users to identify themselves and/or make payments without any physical card or device.

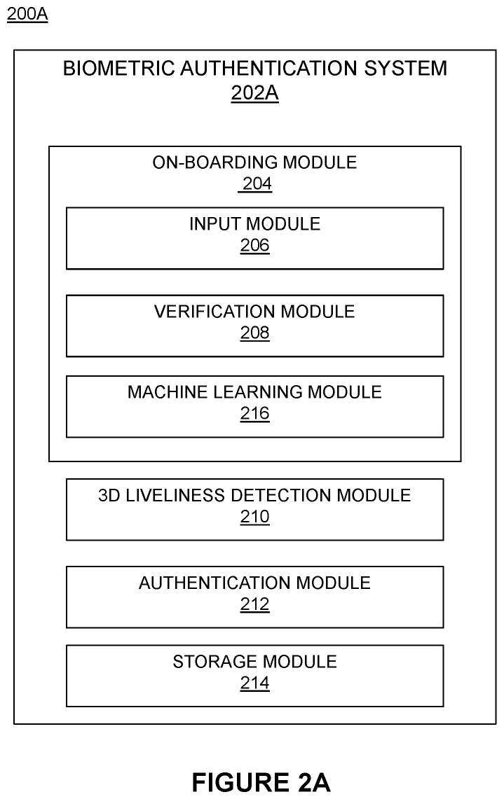

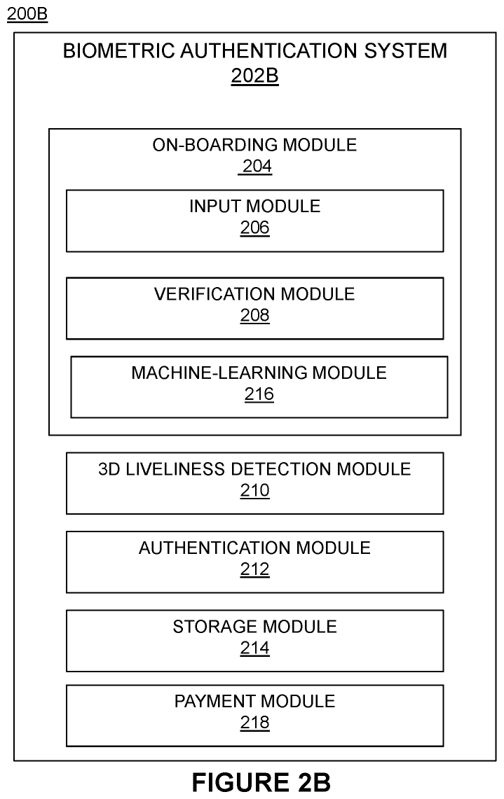

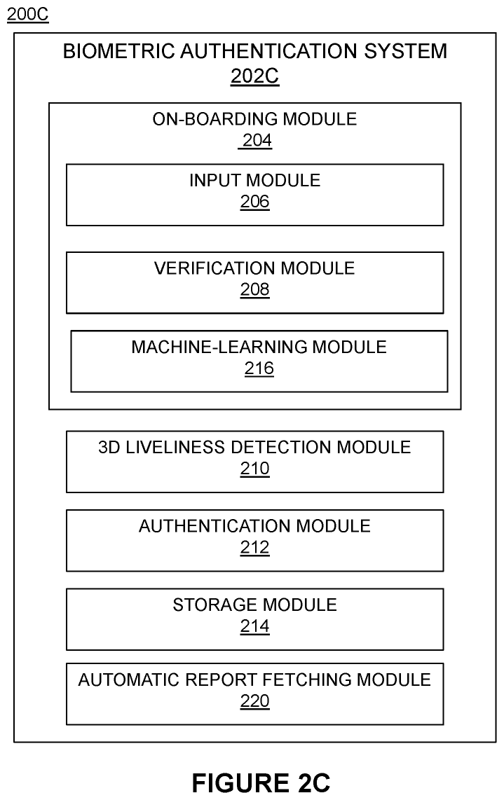

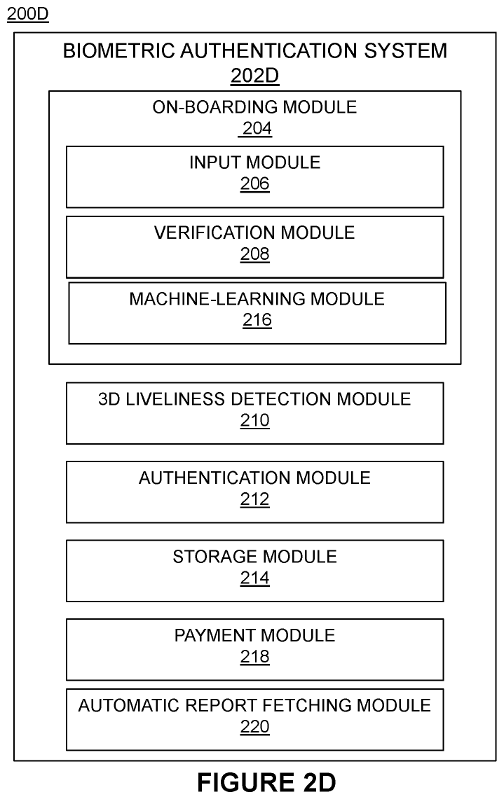

In some embodiments, once the user 102A (or 102B) have registered with the system 104A (or 104B or merchant's biometric authentication system 104C as shown FIG. 1B), the user 102A (or 102B) will be able to make or receive payments. Similarly, the merchant 108A (or 108B) can make or receive payments after registering with the system 104A (or 104B). The merchant 108A may also provide their associated registration information comprising at least one of an image, video, and payment information and other relevant documents like company name etc. For registering with the system 104A (or 104C). As discussed with reference to the FIGS. 1A-1B, the system 104A (or 104C) may create and store a record of the merchant upon successful verification and registration. More details about the structure of the system 104A, 104B or 104C is discussed with reference to the FIGS. 2A-2B.

FIG. 2A is a block diagram 200A illustrating various system elements of an exemplary biometric authentication system 202A, in accordance with an embodiment of the present disclosure. As shown, the biometric authentication system 202A primarily includes an onboarding module 204, which in turn includes an input module 206, a verification module 208 and a machine learning module 216. The biometric authentication system 202A also includes a three-dimensional (3D) liveliness detection module 210, an authentication module 212, and a storage module 214.

Turning now to the FIG. 2B, a block diagram 200B illustrates various system elements of another exemplary biometric authentication system 202B is shown, in accordance with an embodiment of the present disclosure. The biometric authentication system 202B includes a payment module 218 and all the modules 204-216 of the biometric authentication system 202A as discussed with reference to the FIG. 2A.

The biometric authentication system 202A is configured to authenticate a plurality of users (or an identity of the plurality of users) without requesting any device or personal information from the users. The biometric authentication system 202B is configured to authenticate a plurality of users (or an identity of the plurality of users) and process a payment for a transaction between the user 102B (or 102A) and the merchant 108B (or 108A) without requesting any device or personal information from the user 102B (or 102A).

The onboarding module 204 is configured to enable the plurality of users to register with the biometric authentication system 202A. The onboarding module 204 also includes the input module 206, the verification module 208, and the machine-learning module 216. The input module 206 may be configured to receive registration information from a user, such as the user 102A, of the plurality of users. Examples of the registration information may include such as, but not limited to, at least one of image and a video, at least one gesture information, and one or more identity document of the user 102A. In some embodiments, the registration information may include payment information of the user 102A. The image may be a selfie of the user 102A. The video may be a video of the user 102A. The user 102A may capture the image and/or the video in real-time or they may select a previously captured image or the video stored in the first computing device 106A. The non-limiting examples of the one or more identity document may include a driver's license, a permanent account number card, a photo id, a SSN, a passport, a birth certificate, and any government issued identity card or document. Example of the payment information may include a customer reference number, a password for net banking of the user, credit or debit card details, a PayPal account details, a virtual payment means details, a gift card details, store credits, and so forth. In some embodiments, the input module 206 is further configured to receive payment information from the user 102A at the time of registration.

The verification module 208 is configured to verify the registration information with one or more issuing authority (like 112A-112N) to determine whether they are authentic and are associated with the user 102A. Further, the verification module 208 is configured to register the user 102A (or any other user) based on the verification. A record may be created for the user 102A on successful verification and registration. The record may have all the information of the user 102A. In some embodiments, the record of the user 102A may be encrypted for providing extra security. The record of the user 102A (or multiple records of the users) may be stored in the storage module 214. The storage module 214 may be a local storage or may be a centrally located storage device. In some embodiments, the verification module 208 may verify the payment information of the user 102A and associates the payment information with the record of the user 102A. The verification module 208 may verify the payment information by coordinating with respective issuing authority of the one or more issuing authority. For example, when the payment information includes credit card details of the user 102A, then the verification module 208 may verify the credit card details with a bank that issued the credit card. In some embodiments, the record of the user 102A may include the image and/or video of the user 102A and the identity document and/or payment information of the user 102A.

The three-dimensional (3D) liveliness detection module 210 is configured to scan a face of the user 102A. Further, the 3D liveliness detection module 210 may also create a 3D face map of the user 102A in real-time based on the scanning. The face map may be stored in the storage module 214 in some embodiments. In some embodiments, the face map of the user 102A may be stored temporarily in the storage module 214. In some embodiments, the 3D liveliness detection module 210 is a contactless module and is further configured to perform an instant liveliness test from at least one of the video, image and the face scan of the user 102A. The at least one of the video, the image, and the face scan may be captured by a computing device such as the first computing device 106A of the user 102A. In some embodiments, the 3D liveliness detection module 210 is also configured to measure one or more properties from the created 3D map of the user 102A. The one or more properties may include a 3D depth, skin texture, eye reflections of the user 102A, and so forth. In some embodiments, the 3D liveliness detection module 210 may also be configured to delete the face map of the user 102A after completion of the searching of the matching record.

The authentication module 212 is configured to authenticate an identity of the user 102A by searching for a matching record based on the face scan from a plurality of pre-stored records of the plurality of users. The pre-stored records may be stored in the storage module 214. The user 102A is authenticated when the matching record is found. The authentication module 212 may prompt the user 102A to register with the system 202A when the matching record is not found. The system 202A may not request any personal information from the user 102A for authentication. In some embodiments, the authentication module 212 is configured to determine if the user is who they claim to be by leveraging the one or more identity document and at least one of the image and video (or audio) of the user 102A.

The storage module 214 may store the information about the plurality of users and merchants registered with the system 202A (or 202B), records of the users, and so forth.

The machine learning module 216 is configured to: continuously update onboarded users' personal data and facial features in their respective records; detect blur and bad image; and perform data tagging to identify at least one of if the image was scuffed, if the identity document had a hole punched, which country was the identity document from, if there is a glare in the video or image, and if part of the video or image is obscured by a thumb. In other embodiments, the authentication module 212 may authenticate the user 102A based on at least one of an image, a video (or audio) of the user 102A, and an identifier provided by the user 102A.

Turning now to the FIG. 2B, the payment module 218 is configured to process a payment for a transaction of the user 102A based on the authentication of the user 102A without requesting any personal information from the user 102A.

FIG. 2C is a block diagram 200C illustrating various system elements of another exemplary biometric authentication system 202C, in accordance with an embodiment of the present disclosure. The biometric authentication system 202C includes an automatic report fetching module 220 and all the modules 204-216 of the biometric authentication system 202A as discussed with reference to the FIG. 2A.

In some embodiments, the onboarding module 204 of the biometric authentication system 202C enables the user 102A to link/upload his/her reports such as but not limited to, medical reports, financial reports, bank statements, visa document, marksheets, driving license, agreements, contracts, etc. After onboarding or registering with the system 202C. The authentication system 212 further enables the user 102A to authorise an entity (such as, a person or a company or a website or a mobile application) to access his/her reports. The user 102A can upload the reports for example by either taking a picture, scanning or inputting data, the onboarding module 204 may link the reports together. The non-limiting examples of the entity may include a medical staff, a doctor, a server, a bank staff, an immigration officer,

The automatic report fetching module 220 may enable an entity authorised by the user 102A to access at least one report of the one or more reports of the user 102A after authentication of the user 102A. For example, when the user 102A requires any medical services at a medical clinic, an entity i.e., a medical staff may verify the user 102A using the system 202C on his/her computing device and the user can authenticate the entity using the system 202C on his/her computing device. Once authenticated, the medical staff can access one or more reports such as user's blood test report on his/her computing device via the automatic report fetching module 220. This way, the user 102A may not have to carry his/her reports physically. In some embodiments, the automatic report fetching module 220 allows the user 102A to enable restrictions or customize access of the one or more reports for different entities. For example, the user 102A may set restrictions for the medical staff that may only be able to see user's blood test reports or other medical documents of the user 102A uploaded into the system 202C. This way, the user 102A may define various level of access restrictions for different type of entities.

FIG. 2D is a block diagram 200D illustrating various system elements of another exemplary biometric authentication system 202D, in accordance with an embodiment of the present disclosure. The biometric authentication system 202D includes the automatic report fetching module 220 and all the modules 204-218 of the biometric authentication system 202B as discussed with reference to the FIG. 2B. The user 102A can allow an entity like the medical staff to automatically view user's medical reports and can also pay for the medical services using the biometric authentication system 202D. In some embodiments, the merchant 108A may be an entity i.e., a person, a company, a mobile application, or a website that may access the system 104A for viewing one or more reports (e.g., medical reports, visa documents, financial reports, ID documents etc.) of the user 102A. The entity may be a pre-authorised by the user 102A. In some embodiments, the user 102A may authorise the entity at the time the entity request access to the reports of the user 102A.

FIGS. 3A-3B is a flowchart diagram illustrating a method 300 for authenticating a user by using the exemplary biometric authentication system 202A of FIG. 2A, in accordance with an embodiment of the present disclosure. The method 300 initiates at step 302.

At step 302, the system 202A receives registration information from a user such as the user 102A as discussed with reference to the FIG. 1A. In some embodiments, the input module 206 receives the registration information from a user on the first computing device 106A. The received information may include an image and/or a video of the user 102A. In some embodiments, the registration information may also include at least one identity document of the user 102A.

At step 304, the system 202A verifies the received registration information by checking for their authenticity with the one or more issuing authority 112A-112N. In some embodiments, the verification module 208 verifies the at least one identity document received from the user 102A.

Then at step 306, the system 202A registers the user 102A with the system 202A by creating a record for the user 102A based on the verification. In some embodiments, the verification module 208 registers the user 102A and creates the record for the user 102A. The record may be stored in the storage module 214.

At step 308, at least one body part such as, but not limited to, the face of the user 102A is scanned. In some embodiments, the scanning of the face may happen at the merchant's second computing device 110A. Further, the 3D liveliness detection module 210 may scan the face of the user 102A.

At step 310, the system 202A may create a 3D face map of the user 102A based on the face scan (or body scan). In some embodiments, the 3D liveliness detection module 210 may create a 3D face map of the user 102A based on the face scan (or body scan). The scanning may be contactless scanning.

At step 312, the system 202A searches for a matching record from a plurality of records stored in the storage module 214 based on the face scan (or other body scan). In some embodiments, the authentication module 212 may search for the matching record from the plurality of records stored in the storage module 214 based on the face scan (or other body scan).

At step 314, the system 202A checks if the matching record is found. If the matching record is found then a step 316 is executed else a step 318 is executed. At step 316, the authentication module 212 authenticates the user 102A as the matching record is found for the user 102A.

When the matching record is not found for the user 102A at step 314, then at step 318, the system 202A may prompt the user 102A to register with the system 202A. And then control goes to the step 302 and the steps 302-314 are executed until a matching record is found of the user 102A.

FIG. 4 is a flowchart diagram illustrating a method 400 for authenticating a user by using the exemplary contactless biometric authentication system 202B of FIG. 2B, in accordance with an embodiment of the present disclosure. The method initiates at step 402.

At step 402, an access of the biometric authentication system such as the system 202B is provided to a user, such as the user 102A as discussed with reference to the FIG. 1A, for registration. Then at step 404, onboarding process of the user 102A is started by the onboarding module 204 of the system 202B.

Then at step 406, the system 202B scans at least one identity document of the user 102A issued by an issuing authority. In some embodiments, the user 102A may scan more than one identity document. In some embodiments, the user 102A may scan or capture an image of the identity document by using a camera of the first computing device 106A.

At step 408, the system 202B may enable the user 102A to take and upload a selfie such as an image or a video. In some embodiments, the input module 206 receives the selfie of the user 102A or at least one gesture from the user 102A.

Then at step 410, the system 202B enables the user 102A to upload payment information or additional documents such as, but not limited to, passport, utility bills' payment information etc.

Then at step 412, the system 202B enables the user 102A to elect an authentication method such as gesture or voice recognition. Thereafter at step 414, the system 202B verifies the document and information to create a record for the user 102A. In some embodiments, the verification module 208 verifies the document and information to create a record for the user 102A and stores the record in the storage module 214.

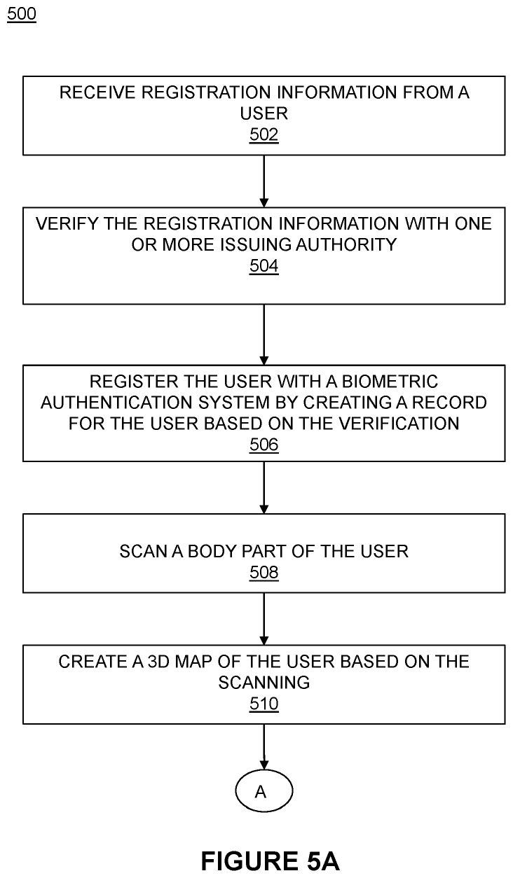

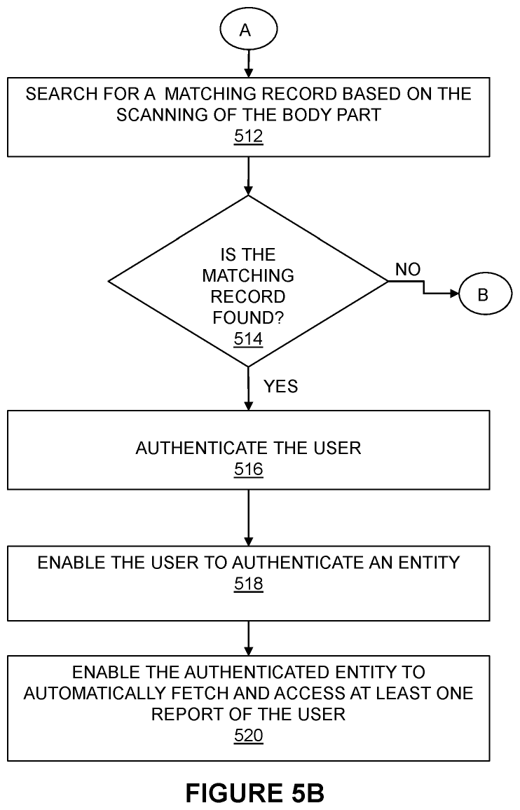

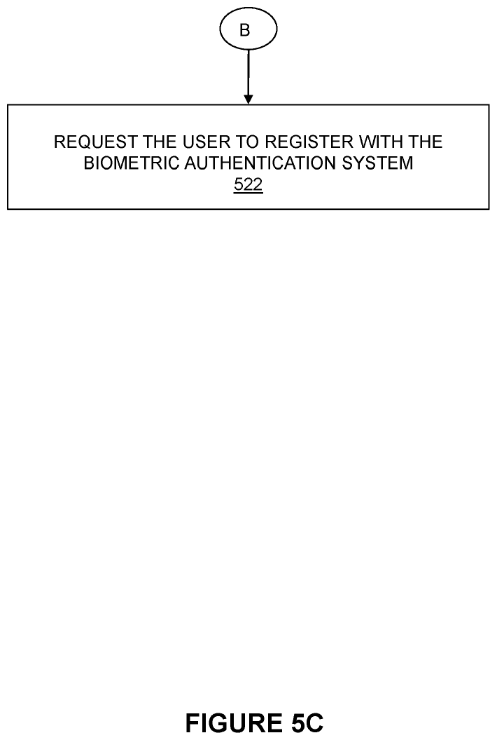

FIGS. 5A-5C is a flowchart diagram illustrating a method 500 for authenticating a user by using the exemplary biometric authentication system 202C of FIG. 2C, in accordance with an embodiment of the present disclosure. The method 500 initiates at step 502.

At step 502, the system 202C receives registration information from a user such as the user 102A as discussed with reference to the FIG. 1A. In some embodiments, the onboarding module 204 or the input module 206 receives the registration information from the user 102A on the first computing device 106A. The received information may include an image and/or a video of the user 102A. In some embodiments, the registration information may also include at least one identity document of the user 102A. In some embodiments, the user 102A may also upload one or more reports such as, but not limited to, medical reports, blood test reports, bank statements, contracts, agreements, visa documents, books, bills, payment details, marksheets, membership identity documents, identity cards, and so forth.

At step 504, the system 202C verifies the received registration information by checking for their authenticity with the one or more issuing authority 112A-112N. In some embodiments, the verification module 208 verifies the at least one identity document received from the user 102A.

Then at step 506, the system 202C registers the user 102A with the system 202A by creating a record for the user 102A based on the verification. In some embodiments, the verification module 208 registers the user 102A and creates the record for the user 102A. The record may be stored in the storage module 214.

At step 508, at least one body part such as, but not limited to, the face, palm, a gesture of the user 102A is scanned. In some embodiments, the scanning of the body part may happen at the merchant's second computing device 110A. Further, the 3D liveliness detection module 210 may scan the body part of the user 102A.

At step 510, the system 202C may create a 3D map of the body part of the user 102A based on the scanning of the body part. In some embodiments, the 3D liveliness detection module 210 may create a 3D map of the body part of the user 102A based on the body scan. The scanning may be contactless scanning.

At step 512, the system 202C searches for a matching record from a plurality of records stored in the storage module 214 based on the scanning of the body part. In some embodiments, the authentication module 212 may search for the matching record from the plurality of records stored in the storage module 214 based on the scanning of the body part.

At step 514, the system 202C checks if the matching record is found. If the matching record is found then a step 516 is executed else a step 522 is executed.

At step 516, the authentication module 212 authenticates the user 102A as the matching record is found for the user 102A. At step 518, the authentication module 202 enables the user 102A to authenticate an entity. The entity may be a company, a person or a website.

At step 520, the automatic report fetching module 220 enables the authenticated entity to automatically fetch and access the one or more reports (or the report for which the user 102A has provided access to the entity).

When the matching record is not found for the user 102A at step 514, then at step 522, the system 202C may prompt the user 102A to register with the system 202C. Thereafter, the control goes to the step 502 and the steps 502-514 are executed until a matching record is found for the user 102A. Alternatively, the user 102A may use any other method to authorise the entity and provide report to the entity, for example, the user 102A may show a physical report to the entity or may show the report on his/her computing device.

The disclosed contactless biometric authentication system may allow the users to identify themselves and/or make payments without any physical card or device.

In some embodiments, one or more merchants can access the contactless biometric authentication system through their associated computing device and may not require any special device or EFTPOS machine to scan a person and identify them or process a payment for the person. Examples of the computing device may include, but are not limited to, a mobile phone, a laptop, a tablet computer, a computer, a smart watch, a fitness tracker, a smart television, an image/video capturing device, and so forth.

The disclosed contactless biometric authentication system may be used by financial services industries to meet their KYC/AML obligations such as Banks, global financial institutions, foreign exchange providers, international money transfer agencies. The contactless biometric authentication system may be used for funds management, superannuation, lending Institutes etc. catch fake IDs and prevent fraud while simplifying the experience for their customers. The contactless biometric authentication system may be used for meet KYC/AML requirements and country specific regulations. The disclosed contactless biometric authentication system may also eliminate manual ID verification processes. Further, the disclosed contactless biometric authentication system may accelerate customer onboarding and transactions. Further, the disclosed system may simplify user experience without compromising security.

The disclosed contactless biometric authentication system may be used by the Security agencies, Police, Border Security where person is simply scanned to know who they are on the spot.

Further, the contactless biometric authentication system may be used by legal firms to identify their clients remotely and streamline their identification processes, particularly for digital legal providers who onboard their clients on subscriptions-based services.

The contactless biometric authentication system is configured for 3D face authentication. Further, the system has cross device (mobile phone, computer, laptop, camera, etc.) or cross platform (Android, iOS etc.) portability.

The present disclosure provides a contactless biometric authentication system and method for authenticating an identity of a user based on 3D scanning of at least one body part such as, but not limited to, a face of the user and/or authorising a payment accordingly without requiring the user to present a physical or virtual payment means.

The present disclosure provides a contactless biometric authentication system configured to allow one or more businesses to establish genuine identity (ID) of their users by verifying government issued IDs in real time. The system is configured to enable a user to link a payment solution such as, but not limited to, a debit card, a PayPal account, a credit cards, bank account with the system to process payments once user's ID has been verified. The system may also be configured to instantly issue other payment methods such as virtual payments cards based on the verification of the user's identity. Further, the system may allow the user to use cryptocurrency to make payments to merchants or the businesses accepting cryptocurrency.

According to an embodiment of the present disclosure, there is provided a biometric authentication system for authenticating a plurality of users without requesting any personal information or device from the plurality of users. The system includes an onboarding module configured to enable the plurality of users to register with the biometric authentication system. The onboarding module includes an input module configured to receive registration information from a user of the plurality of users, wherein the registration information comprises at least one of image, a video and one or more identity document of the user. The onboarding module further includes a verification module configured to verify the registration information with one or more issuing authority to determine whether they are authentic and are associated with the user; and register the user based on the verification, wherein a record is created for the user on successful verification and registration. The system also includes a three-dimensional (3D) liveliness detection module configured to: scan a face of the user; and create a 3D face map of the user in real-time based on the scanning. The system also includes an authentication module configured to authenticate an identity of the user by searching for a matching record based on the face scan from a plurality of pre-stored records of the plurality of users. The user is authenticated when the matching record is found, further wherein the authentication module prompts the user to register when the matching record is not found, wherein no personal information is requested from the user for authentication.

The disclosed system may identify the individual (or the user) during the on-boarding process, which can be used to identify individuals and may eliminate manual verification process.

The disclosed system may identity verification of the user or individual first and then link the payment method.

In some embodiments of the present disclosure, the authentication module may be configured to determine if the user is who they claim to be by leveraging the one or more identity document and at least one of the image and video of the user.

According to another aspect of the present disclosure, the 3D liveliness detection module is a contactless module and is further configured to: perform an instant liveliness test from at least one of the video, image and the face scan of the user; and measure one or more properties from the created 3D map of the user, wherein the one or more properties comprises a 3D depth, skin texture, and eye reflections of the user.

According to another aspect of the present disclosure, wherein the 3D liveliness detection module is further configured to delete the face map of the user after completion of the searching of the matching record.

According to another aspect of the present disclosure, the biometric authentication system also includes a machine learning module configured to: continuously update onboarded users' personal data and facial features in their respective records; detect blur and bad image; and perform data tagging to identify at least one of if the image was scuffed, if the identity document had a hole punched, which country was the identity document from, if there is a glare in the video or image, and if part of the video or image is obscured by a thumb.

According to another aspect of the present disclosure, the input module is further configured to receive payment information from the user at the time of registration.

According to another aspect of the present disclosure, the verification module may verify the payment information and associate the payment information with the record of the user, wherein the verification module verifies the payment information by coordinating with respective issuing authority of the one or more issuing authority. The respective issuing authority may be an authority or third party that issued the payment information to the user.

According to another aspect of the present disclosure, the biometric authentication system also includes a payment module configured to process a payment for a transaction of the user based on the authentication of the user without requesting any personal information from the user.

According to another aspect of the present disclosure, the authentication module may authenticate the user based on at least one of an image, a video of the user, and an identifier provided by the user.

According to another embodiment of the present disclosure, there is provided a method for authenticating a plurality of users without requiring the plurality of users to present any device or personal information, comprising enabling, by an onboarding module, the plurality of users to register with a biometric authentication system by: receiving, by an input module, registration information from a user of the plurality of users, wherein the registration information comprises at least one of image and a video and one or more identity document of the user; and verifying, by a verification module, the registration information with one or more issuing authority to determine whether they are authentic and are associated with the user; and registering, by the verification module, the user based on the verification, wherein a record is created for the user on successful verification and registration. The method also includes scanning, by a three-dimensional (3D) liveliness detection module, a face of the user; and creating, by the 3D liveliness detection module, a 3D face map of the user in real-time based on the scanning. The method further includes authenticating, by an authentication module, an identity of the user by searching for a matching record based on the face scan from a plurality of pre-stored records of the plurality of users, wherein the user is authenticated when the matching record is found, further wherein the authentication module prompts the user to register when the matching record is not found, wherein no personal information is requested from the user for authentication.

In some embodiments of the present disclosure, the method further comprising, determining, by the authentication module, if the user is who they claim to be by leveraging the one or more identity document and at least one of the image and video of the user.

According to another aspect of the present disclosure, the method further includes performing, by the 3D liveliness detection module, an instant liveliness test from at least one of the video, audio, image, and the face scan of the user. The 3D liveliness detection module is a contactless module. The at least one of the video, the image, and the face scan is captured by a computing device for example by a smart phone of the user.

According to another aspect of the present disclosure, the method further includes measuring, by the 3D liveliness detection module, one or more properties from the created 3D map of the user, wherein the one or more properties comprises a 3D depth, skin texture, and eye reflections of the user.

According to another aspect of the present disclosure, the method also includes deleting, by the 3D liveliness detection module, the face map of the user after completion of the searching of the matching record.

According to another aspect of the present disclosure, the method also includes:
continuously updating, by a machine learning module, onboarded users' personal data and facial features in their respective records; detecting, by the machine learning module, blur and bad image; and performing data tagging, by the machine learning module, to identify at least one of if the image was scuffed, if the identity document had a hole punched, which country was the identity document from, if there is a glare in the video or image, and if part of the video or image is obscured by a thumb.

According to another aspect of the present disclosure, the method also includes receiving, by the input module, payment information from the user at the time of registration; and verifying, by the verification module, the payment information and associating the payment information with the record of the user by coordinating with respective issuing authority of the one or more issuing authority.

According to another aspect of the present disclosure, the method also includes processing, by a payment module, a payment for a transaction of the user based on the authentication of the user without requesting any personal information from the user.

According to another aspect of the present disclosure, the method further includes authenticating, by the authentication module, the user based on at least one of an image, a video of the user, and an identifier provided by the user. The identifier may be a unique code or pin set by the user during the registration with the system.

According to a yet another embodiment of the present disclosure, there is provided a contactless biometric authentication system for authenticating a plurality of users without requiring the plurality of users to present any device or personal information. The system includes an onboarding module configured to enable the plurality of users to register with the contactless biometric authentication system, comprising: an input module configured to receive registration information from a user of the plurality of users, wherein the registration information comprises at least one of image and a video, one or more identity document, and payment information of the user; and a verification module configured to: verify the registration information with one or more issuing authority to determine whether they are authentic and are associated with the user; verify the payment information and associates the payment information with the record of the user; and register the user based on the verification, wherein a record is created for the user on successful verification and registration. The system also includes a three-dimensional (3D) liveliness detection module configured to: scan at least one body part of the user; and create a 3D map of the user in real-time based on the scanning. Further, the system also includes an authentication module configured to authenticate an identity of the user by searching for a matching record based on the scan from a plurality of pre-stored records of the plurality of users, wherein the user is authenticated when the matching record is found. The authentication module may prompt the user to register with the system when the matching record is not found, wherein no personal information is requested from the user for authentication. The system also includes a payment module configured to process a payment for a transaction of the user based on the authentication of the user.

According to an aspect of the present disclosure, the at least one body part comprises at least one of a face, a palm, a thumb, at least one finger, and at least one eye of the user.

The disclosed contactless biometric authentication system may radically reduce the time patrol officers need to identify persons of interest in the field and identify suspects in seconds not hours; Photograph suspects from a safe distance; Install enroll mugshots from the field; Break through language barriers during the ID process. Further, the disclosed system may ensure dangerous fugitives don't slip through the cracks; and may minimize false arrests. Furthermore, the disclosed system may be used to secure access to courthouse, jails and sensitive areas.

The disclosed system may be used by Paramedics, Doctors, Emergency services personnel to identify patients and access their secured medical records for either personally or remotely consulting patients. Further, the entity may include Paramedics, Doctors, Emergency services personnel, bank professionals, immigration officer, and so forth.

Further, the system may enable each registered user or business to make and receive contactless payments.

The disclosed system may enable the user to upload one or more reports like medical records and set access permission for entities. The user can customize the access permission for different entities. For example, the user can provide access of medical records to medical professional and visa document access to immigration professional. The system may be used by medical professional such as, medical staff for getting emergency access to medical records or identification when the user is not responding or unable to identify themselves (accidents, too drunk, semi-conscious). In some embodiments, the medical professional may use the system on their computing device like smart phone. After verifying the user, the system displays the medical records on the computing device of the medical professional. The user may not have to authorise the access of the medical records to the medical professional as the medical records are displayed based on the previously set access permissions.

The disclosed system is configured to perform 3D liveness detection to protect a system from unauthorised access and true real time liveness detection is absolutely critical for the security of biometric systems, whether it is for user identity for login or remote onboarding and enrollment. Further, the system is configured to combat fraudsters who attempt to use static images or a pre-recorded video to “fake” their identity. The system may create a 3D face map and performs an instant liveness test from a quick video-selfie taken on user's smartphone or webcam. Further, the contactless biometric authentication system is configured to do 3D depth detection by measuring 3D depth, skin textures, eye reflections, etc. Further, the system is configured to distinguish between identical twins as is has a False Acceptance Rate (FAR) of 1/4,200,000 FAR and a False Rejection Rate (FRR) of less than 1. Further, the system provides match to photo identification as it is configured to perform 2D-3D matching resulting in high match levels. Furthermore, the system provides better than human anonymous age estimation. The system is configured to delete data after matching. Further, the system is password protected which is universal and highly secure and convenient for its users.

In some embodiments, the system is configured to use Machine Learning is to continuously update onboarded users' personal data and facial features; detect blur and bad image. Further, the system uses machine learning to tag data to identify: if the image was scuffed; if the ID had a hole punched; which country was the ID from; was there a glare; Was part of the image obscured by a thumb.

The system is configured to conduct identity proofing by leveraging a government-issued ID and a selfie to know if the user is really who they claim to be. The system is configured to store user face maps. Further, the system provides cross-platform Portability to the users. For example, the users can enroll using a webcam and authenticate latter from a smartphone (and vice versa). Further, the system provides a streamlined user experience to provide an intuitive, user-friendly experience on all channels without compromising security. The system enables fast authentication to speed up the authentication process and deliver a definitive match/no match determination in seconds. The system may use a selfie for authentication without repeating the ID document proofing process. The system may help in fraud prevention by deterring would be fraudsters and protect against sophisticated spoofing attempts. The system provides an identity authentication that is stronger than passwords as it leverages biometric-based face maps to deliver a significantly more reliable authentication experience than passwords, Two-Factor Authentication (2FA) and Knowledge Based Authentication (KBA). Further, the system is configured for adaptive learning as the system learn more about the user's face from each and every authentication. The system may use same biometric data for both identity proofing and authentication. The system may be compatible with different operating systems or platforms such as, but not limited to, native iOS/Android, and Web

Further, the system may combat spoofing attacks where an artifact in lieu of a real person is presented for verification such as photos, video, playback, masks, voice recording or even just voice impersonations. This protects the system from unauthorised access.

Further, the system may be used by merchants and retailers for online identifications by scanning a face before making or processing a payment to verify purchaser and use associated payment method to make payment. By using the disclosed system, the online retailers may have less online financial transaction disputes and reduce chargeback and refunds due to proof of purchase being biometric. The system may enable a merchant or business to identify clients seamlessly and record this against transactions such as pick up or delivery service.

In some embodiments, the contactless biometric authentication system may be used by businesses for fast and easy onboarding of their customers; to identify their customers using biometrics; to meet their KYC/AML obligations; to reduce fraud. The systems may provide better customer experience as its quick, contactless, and also doesn't require any user's information (like phone number etc.). Additionally, the user may not have to carry any device for authentication and payment. Further, the system may maintain biometric record for transactions.

The system may allow consumers (or users) to authenticate their identity and/or make payments to businesses and merchants without providing any other physical identification. Therefore, the user may not require to carry ID card or digital device. The system may relieve the consumers from the fear of unauthorised access that may happen due to lost or stolen cards. The system may prevent the consumers from ID fraud situations.

In some embodiments, the system may enable the government to transact and implement biometric ID solutions for all government transactions and also to track any fraudulent activity to person committing it.

The disclosed contactless biometric authentication system is configured to identify a user or person without any documentation or device. The user may be a person registered with the system. Further, the system may enable the registered users to make payments, conduct financial transactions without any physical payment cards or devices (like mobile phone etc.).

In some embodiments, the disclosed biometric authentication system includes an automatic report fetching module to allow an entity to access reports of the user. In some embodiments, the user may use biometric authentication system on his/her computing device to authenticate the entity and to provide access of the one or more reports to the entity.

In some embodiments, the disclosed biometric authentication system enables the user to link his/her reports such as but not limited to medical records, financial records etc. After onboarding or registering with the system. The system enables the user to authorise an entity (such as, a person or a company or a website or a mobile application) to access their reports (medical records or any other records). The user can upload the reports for example by either taking a picture, scanning or inputting data on the onboarding module, the system may link the reports or the onboarding module (or application) together.

For example, once linked then e.g., COVID19 Test report linked to an ID of the user then upon scanning by an entity or the onboarding module at a computing device of the entity (e.g., at hotel, restaurants, cafe's, airlines, airport etc.). The system will automatically fetch a visual of this report which they may save, email or print etc. As per their choice. The system enables the user to customize to access only the report(s) that the entity would or may need. Therefore, the user may only give access to ID and COVID19 Test Result as either Pass or Fail etc.

In another exemplary scenario, the ambulance or medical staff can authorise the user and accordingly the user may authorise them and provide them access to user's medical reports.

In some embodiments, the verifier module may be used in clubs, libraries, universities, schools, gyms, colleges, or anywhere that require a physical membership or ID card where they scan their members or users to provide access to record attendance. In some embodiments, the disclosed system comprising the verifier module may be used for verifications of voters and their address via ID documents and recording their attendance.

In some embodiments, the disclosed system can be used to identity or verify addresses for example, to prove Residential Address verification, date of birth (DOB), Driver's license and passport details after being authorised by the user to the entity (or may be referred as a verifier without change in its meaning).

It will be understood that the devices and the databases referred to in the previous sections are not necessarily utilized together method or system of the embodiments. Rather, these devices are merely exemplary of the various devices that may be implemented within a computing device or the server device, and can be implemented in exemplary another device, and other devices as appropriate, that can communicate via a network to the exemplary server device.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above disclosed and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

What is claimed is:

1. A biometric authentication system for authenticating a plurality of users without requesting any personal information or device from the plurality of users, comprising:
an onboarding module configured to enable the plurality of users to register with the biometric authentication system, comprising:
an input module configured to receive registration information from a user of the plurality of users, wherein the registration information comprises at least one of image, a video, one or more reports, and one or more identity document of the user;
a machine learning module configured to detect blur and bad image in the registration information; and
a verification module configured to:
verify the registration information with one or more issuing authority to determine whether they are authentic and are associated with the user; and
register the user based on the verification, wherein a record is created for the user on successful verification and registration;
a three-dimensional (3D) liveliness detection module configured to:
scan a face of the user; and
create a 3D face map of the user in real-time based on the scanning; and
an authentication module configured to authenticate an identity of the user by searching for a matching record based on the scanning of the face from a plurality of pre-stored records of the plurality of users, wherein the user is authenticated when the matching record is found, further wherein the authentication module prompts the user to register when the matching record is not found, wherein no personal information is requested from the user for authentication, wherein the 3D liveliness detection module deletes the 3D face map of the user after completion of the searching of the matching record.

2. The biometric authentication system of claim 1, wherein the authentication module is further configured to determine if the user is who they claim to be by leveraging the one or more identity document and at least one of the image and video of the user.

3. The biometric authentication system of claim 1, wherein the 3D liveliness detection module is a contactless module and is further configured to:
perform an instant liveliness test from at least one of the video, image and the face scan of the user; and
measure one or more properties from the created 3D map of the user, wherein the one or more properties comprises a 3D depth, skin texture, and eye reflections of the user.

4. The biometric authentication system of claim 1, wherein the machine learning module is further configured to:
perform data tagging to identify at least one of if the image was scuffed, if the identity document had a hole punched, which country was the identity document from, if there is a glare in the video or image, and if part of the video or image is obscured by a thumb; and
continuously update onboarded users' personal data and facial features in their respective records.

5. The biometric authentication system of claim 1, wherein the input module is further configured to receive payment information from the user at the time of registration.

6. The biometric authentication system of claim 5, wherein the verification module verifies the payment information and associates the payment information with the record of the user, wherein the verification module verifies the payment information by coordinating with respective issuing authority of the one or more issuing authority.

7. The biometric authentication system of claim 6 further comprising a payment module configured to process a payment for a transaction of the user based on the authentication of the user without requesting any personal information from the user.

8. The biometric authentication system of claim 1, wherein the authentication module authenticates the user based on at least one of an image, a video of the user, and an identifier provided by the user.

9. The biometric authentication system of claim 1 further comprising an automatic report fetching module configured to enable an entity authorised by the user to access at least one report of the one or more reports of the user after authentication of the user.

10. A method for authenticating a plurality of users without requiring the plurality of users to present any device or personal information, comprising:
enabling, by an onboarding module, the plurality of users to register with a biometric authentication system by:
receiving, by an input module, registration information from a user of the plurality of users, wherein the registration information comprises at least one of image and a video and one or more identity document of the user;
detecting, by a machine learning module, blur and bad image in the registration information; and
verifying, by a verification module, the registration information with one or more issuing authority to determine whether they are authentic and are associated with the user; and
registering, by the verification module, the user based on the verification, wherein a record is created for the user on successful verification and registration;
scanning, by a three-dimensional (3D) liveliness detection module, a face of the user;
creating, by the 3D liveliness detection module, a 3D face map of the user in real-time based on the scanning;
authenticating, by an authentication module, an identity of the user by searching for a matching record based on the scanning of the face from a plurality of pre-stored records of the plurality of users, wherein the user is authenticated when the matching record is found, further wherein the authentication module prompts the user to register when the matching record is not found, wherein no personal information is requested from the user for authentication; and
deleting, by the 3D liveliness detection module, the 3D face map of the user after completion of the searching of the matching record.

11. The method of claim 10 further comprising, determining, by the authentication module, if the user is who they claim to be by leveraging the one or more identity document and at least one of the image and video of the user.

12. The method of claim 10 further comprising:
performing, by the 3D liveliness detection module, an instant liveliness test from at least one of the video, image and the face scan of the user, wherein the 3D liveliness detection module is a contactless module; and
measuring, by the 3D liveliness detection module, one or more properties from the created 3D map of the user, wherein the one or more properties comprises a 3D depth, skin texture, and eye reflections of the user.

13. The method of claim 10 further comprising:
continuously updating, by the machine learning module, onboarded users' personal data and facial features in their respective records; and
performing data tagging, by the machine learning module, to identify at least one of if the image was scuffed, if the identity document had a hole punched, which country was the identity document from, if there is a glare in the video or image, and if part of the video or image is obscured by a thumb.

14. The method of claim 10 further comprising:
receiving, by the input module, payment information from the user at the time of registration; and
verifying, by the verification module, the payment information and associating the payment information with the record of the user by coordinating with respective issuing authority of the one or more issuing authority.

15. The method of claim 14 further comprising processing, by a payment module, a payment for a transaction of the user based on the authentication of the user without requesting any personal information from the user.

16. The method of claim 10 further comprising:
authenticating, by the authentication module, the user based on at least one of an image, a video of the user, and an identifier provided by the user;
enabling, by the authentication module, the user to authorise an entity; and
enabling, by an automatic report fetching module, the authorised entity by the user to access at least one report of the one or more reports of the user after authentication of the user.

17. A contactless biometric authentication system for authenticating a plurality of users without requiring the plurality of users to present any device or personal information, comprising:
an onboarding module configured to enable the plurality of users to register with the contactless biometric authentication system, comprising:
an input module configured to receive registration information from a user of the plurality of users, wherein the registration information comprises at least one of image and a video, a gesture, one or more identity document, and payment information of the user; and
a verification module configured to:
verify the registration information with one or more issuing authority to determine whether they are authentic and are associated with the user;
verify the payment information and associates the payment information with the record of the user; and
register the user based on the verification, wherein a record is created for the user on successful verification and registration;
a three-dimensional (3D) liveliness detection module configured to:
scan at least one of a body part, a facial expression, and a gesture of the user; and
create a 3D map of the user in real-time based on the scanning; and
an authentication module configured to authenticate an identity of the user by searching for a matching record based on the scanning from a plurality of pre-stored records of the plurality of users, wherein the user is authenticated when the matching record is found, further wherein the authentication module prompts the user to register when the matching record is not found, wherein no personal information is requested from the user for authentication, wherein the 3D liveliness detection module deletes the 3D map of the user after completion of the searching of the matching record; and
a payment module configured to process a payment for a transaction of the user based on the authentication of the user.

18. The contactless biometric authentication system of claim 17, wherein the at least one body part comprises at least one of a face, a palm, a thumb, at least one finger, hand, and at least one eye of the user.

19. The contactless biometric authentication system of claim 17 further comprising an automatic report fetching module configured to enable an entity authorised by the user to access at least one report of the one or more reports of the user after authentication of the user.

20. A biometric authentication system for authenticating a plurality of users without requesting any personal information or device from the plurality of users, comprising:
an onboarding module configured to enable the plurality of users to register with the biometric authentication system, comprising:
an input module configured to receive registration information from a user of the plurality of users, wherein the registration information comprises at least one of image, a video and one or more identity document of the user;
a machine learning module configured to:
detect blur and bad image; and
perform data tagging to identify at least one of if the image was scuffed, if the identity document had a hole punched, which country was the identity document from, if there is a glare in the video or image, and if part of the video or image is obscured by a thumb; and
a verification module configured to:
verify the registration information with one or more issuing authority to determine whether they are authentic and are associated with the user; and
register the user based on the verification, wherein a record is created for the user on successful verification and registration;
a three-dimensional (3D) liveliness detection module configured to:
scan a face of the user; and
create a 3D face map of the user in real-time based on the scanning;
an authentication module configured to authenticate an identity of the user by searching for a matching record based on the scanning of the face from a plurality of pre-stored records of the plurality of users, wherein the user is authenticated when the matching record is found, further wherein the authentication module prompts the user to register when the matching record is not found, wherein no personal information is requested from the user for authentication, wherein the 3D liveliness detection module deletes the face map of the user after completion of the searching of the matching record; and
an automatic report fetching module configured to enable an entity authorised by the user to access at least one report of the one or more reports of the user after authentication of the user.
